(19) United States
(12) Patent Application Publication
(10) Pub. No.: US 2019/0281918 A1
(43) Pub. Date: Sep. 19, 2019

(54) SHOE AND CONTROL METHOD THEREOF

(71) Applicant: SHENZHEN ROYOLE TECHNOLOGIES CO., LTD., Shenzhen (CN)

(72) Inventors: Fan YANG, Shenzhen (CN); Qi LIN, Shenzhen (CN); Chaogang WANG, Shenzhen (CN)

(21) Appl. No.: 16/432,428

(22) Filed: Jun. 5, 2019

Related U.S. Application Data
(63) Continuation of application No. PCT/CN2016/113660, filed on Dec. 30, 2016.

(51) Int. Cl. A43B 3/00; G06F 3/041; G06F 3/16

(52) U.S. Cl. CPC A43B 3/001; G06F 3/041; G06F 2203/04102; A43B 3/0021; G06F 3/16

(57) ABSTRACT

A shoe includes a sole, a vamp and a touch interaction device. The touch interaction device includes a support body, a light-emitting unit, a flexible touch sensor and a control module. The support body is attached to the vamp, the light-emitting unit is arranged on the support body, and the flexible touch sensor is attached to the support body and covers the light-emitting unit. The flexible touch sensor is configured to detect a touch operation to the light-emitting unit. The control module is electrically coupled to the light-emitting unit and the flexible touch sensor. The control module is configured to control, according to the touch operation detected by the flexible touch sensor and a current working mode of the touch interaction device, the light-emitting unit to change its working states.

### CROSS-REFERENCE TO RELATED APPLICATION(S)

This application is a continuation application of International Application No. PCT/CN2016/113660, filed on Dec. 30, 2016, the entire disclosure of which is hereby incorporated by reference in its entirety.

### TECHNICAL FIELD

The present disclosure relates to the technical field of shoes, and more particularly relates to a shoe capable of interactive games and a control method thereof.

### BACKGROUND

At present, in order to make wearing shoes more interesting, fun shoes products such as shining shoes, music shoes and so on, have already emerged on the market. For example, soles of existing shoes have been embedding with pressure sensors and corresponding light-emitting modules and vocalization modules. When the pressure sensor detects pressure from the wearer's foot, the light-emitting module in the corresponding shoe is triggered to emit light, and the vocalization module in the corresponding shoe is triggered to make a sound, thereby realize the interaction with the wearer by means of sound and light. However, the existing fun shoes are monotonous in function, and usually trigger corresponding functions such as luminous or vocal by detecting sole pressure, which brings poor interaction.

### SUMMARY

In view of the above problems in related art, embodiments of the present disclosure provide a shoe and a control method thereof, to enhance the interaction with a wearer and increase the fun of wearing.

A shoe is provided, which includes a sole and a vamp. The vamp is coupled to the sole, and the sole and the vamp cooperate to define an opening between the vamp and the sole. The shoe further includes a touch interaction device which comprises a support body, a light-emitting unit, a flexible touch sensor and a control module. The support body is attached to the vamp. The light-emitting unit is arranged on the support body. The flexible touch sensor is attached to the support body and covers the light-emitting unit. The flexible touch sensor is configured to detect a touch operation to the light-emitting unit. The control module is electrically coupled to the light-emitting unit and the flexible touch sensor. The control module is configured to control, according to the touch operation detected by the flexible touch sensor and a current working mode of the touch interaction device, the light-emitting unit to change its working states.

A control method of a shoe is provided. The shoe includes a touch interaction device which includes a plurality of light-emitting units, a flexible touch sensor covering the light-emitting units, and a control module electrically coupled to the light-emitting units and the flexible touch sensor. The control method includes the follows. The flexible touch sensor detects a touch operation to the light-emitting units. The control module controls the light-emitting units to change their working states, according to the touch operation detected by the flexible touch sensor and a current working mode of the touch interaction device.

### BRIEF DESCRIPTION OF THE DRAWINGS

In order to more clearly illustrate the technical solutions in the embodiments of the present disclosure, the following descriptions will briefly illustrate the accompanying drawings described in the embodiments.

FIG. 1 is a first schematic structural diagram of a shoe according to an embodiment of the present disclosure.

FIG. 2 is a schematic diagram of a bottom surface of a sole of the shoe illustrated in FIG. 1.

FIG. 3 is a schematic diagram of a support body of the shoe illustrated in FIG. 1.

FIG. 4 is a schematic diagram of a cover of the shoe illustrated in FIG. 1.

FIG. 5 is a second schematic structural diagram of a shoe according to an embodiment of the present disclosure.

FIG. 6 is a third schematic structural diagram of a shoe according to an embodiment of the present disclosure.

FIG. 7 is a first schematic flowchart of a control of a shoe according to an embodiment of the present disclosure.

FIG. 8 is a second schematic flowchart of a control method of a shoe according to an embodiment of the present disclosure.

FIG. 9 is a third schematic flowchart of a control method of a shoe according to an embodiment of the present disclosure.

### DETAILED DESCRIPTION OF ILLUSTRATED EMBODIMENTS

The technical solutions of embodiments of the present disclosure will be described clearly and completely in the following in combination with the accompanying drawings of the embodiments of the present disclosure. Obviously, the described embodiments are merely a part of embodiments of the present disclosure, but not all of the embodiments. All other embodiments obtained by those of ordinary skill in the art without creative efforts based on the embodiments of the present disclosure shall fall within the protection scope of the present disclosure.

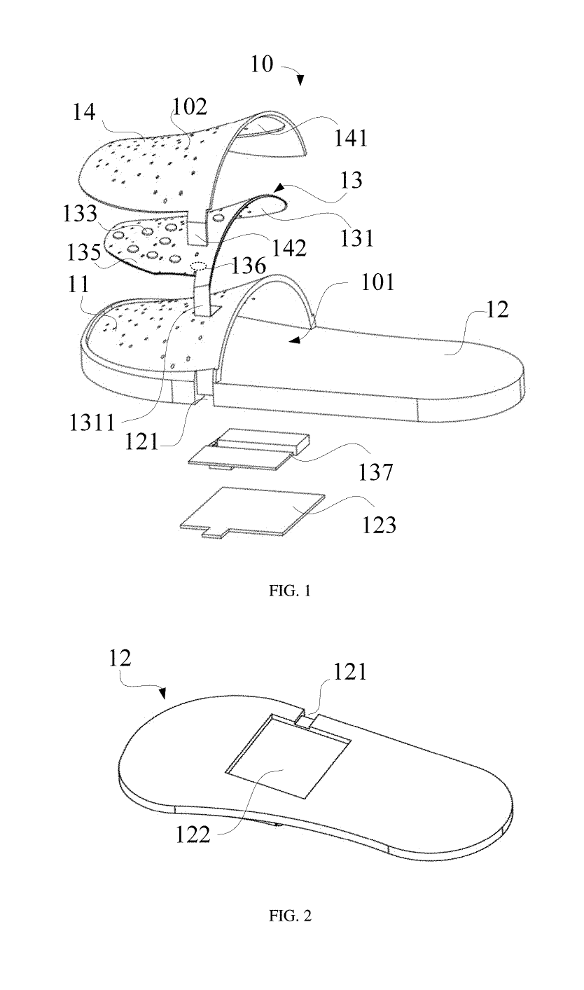

Referring to FIG. 1, in one embodiment of the present disclosure, a shoe 10 is provided, which includes a vamp 11 and a sole 12. The vamp 11 is coupled to the sole 12, and an opening 101 is formed between the vamp 11 and the sole 12 for wearing the shoe 10 for wearing the shoe 10 to a foot of a wearer. The shoe 10 further includes a touch interaction device 13. The touch interaction device 13 includes a support body 131, a light-emitting unit 133, a flexible touch sensor 135, and a control module 137. The support body 131 is attached to the vamp 11. The light-emitting unit 133 is arranged on the support body 131. The flexible touch sensor 135 is attached to the support body 131 and covers the light-emitting unit 133. The control module 137 is electrically coupled to the light-emitting unit 133 and the flexible touch sensor 135.

In the embodiment of the present disclosure, the touch interaction device 13 is able to works in different working modes, such as a game mode, a cool mode, and so on. The flexible touch sensor 135 is configured to detect a touch operation to the light-emitting unit 133. The control module 137 is configured to control, according to the touch operation detected by the flexible touch sensor 135 and a current working mode of the touch interaction device 13, the light-emitting unit to change its working states.

In one embodiment, when the touch interaction device 13 works in a game mode, the control module 137 controls the light-emitting unit 133 to emit light before a touch operation is detected by the flexible touch sensor 135. The amount of the light emitting unit 133 is plural. The control module 137 controls a plurality of the light-emitting units 133 to emit light according to a preset manner. The flexible touch sensor 135 detects a touch operation to the plurality of light-emitting units 133 during a preset time period in which at least one of the light-emitting units 133 is emitting light, and the control module 137 counts up when the touch operation to the light-emitting units 133 is detected. In the embodiment of the disclosure, the light-emitting units 133 are light emitting diodes (LEDs), and the flexible touch sensor 135 is a transparent flexible touch device. It can be understood that, the control module 137 can also control the light-emitting units 133 to emit light after the touch operation is detected by the flexible touch sensor 135.

It can be understood that, the preset manner may be to control the plurality of light-emitting units 133 to randomly emit light, that is, one or more of the light-emitting units 133 is controlled to emit light for a preset time period, and then the one or more of the light-emitting units 133 is automatically turned off, and another one or more of the light-emitting units 133 is randomly controlled to emit light, and repeats the above process. When one of the light-emitting units 133 is turned off after emitting light for the preset time period, the one of the light-emitting units 133 may be controlled to emit light again. The flexible touch sensor 135 covers each of the light-emitting units 133, and can receive and distinguish touch operations to different light-emitting units 133. In this way, while the plurality of light-emitting units 133 are controlled to emit light in the preset manner, the flexible touch sensor 135 may detect the touch operation to each light-emitting unit 133, and determine whether the touch operation is to the light-emitting unit 133 that is currently emitting light, thereby realizing an accumulative counting game similar to the hamster. For example, if a touch operation to a certain light-emitting unit 133 is detected by the flexible touch sensor 135 while the certain light-emitting unit 133 is emitting light, the control module 137 counts up. If a touch operation to a light-emitting unit 133 that isn't currently emitting light is detected by the flexible touch sensor 135, the control module 137 won't count up.

It can be understood that, in one embodiment, the touch interaction device 13 may further include an audio module 136 electrically coupled to the control module 137. When the touch operation to at least one of the light-emitting units 133 that is currently emitting light is detected by the flexible touch sensor 135, the control module 137 is further configured to control the at least one of the light-emitting units 133 to change illuminating colors, and control the audio module 136 to play a prompt tone. For example, if a touch operation to a certain light-emitting unit 133 is detected by the flexible touch sensor 135 while the certain light-emitting unit 133 is emitting light, the control module 137 counts up, and controls the audio module 136 to play a first prompt tone. If a touch operation to a light-emitting unit 133 that isn't currently emitting light is detected by the flexible touch sensor 135, the control module 137 controls the audio module 136 to play a second prompt tone.

When the touch interaction device 13 works in a cool mode, touch operations to different light-emitting units 133 may be received by the flexible touch sensor 135, and the control module 137 may control, according to different positions at which the touch operations are received, at least one of the light-emitting units 133 at the corresponding position to emit light. In addition, the control module 137 may also control, according to different touch operations, the at least one of the light-emitting units 133 at the corresponding position to change their illuminating states. For example, in response to a long-press on a certain area of the flexible touch sensor 135, the control module 137 may control the light-emitting units 133 on the corresponding area to change illuminating colors. In response to a double-click on a certain area of the flexible touch sensor 135, the control module 137 may control the light-emitting units 133 on the corresponding area to maintain a blinking state, etc.

Referring to FIGS. 1 and 2, the sole 12 defines a groove 121 on its one side close to the opening 101, and the touch interaction device 13 is partially received in the groove 121. The sole 12 further defines, on its bottom surface, a recess 122 communicating with the groove 121, and includes a cover plate 123 for sealing the recess 122. The control module 137 is received in the recess 122. It can be understood that, the control module 137 may include a power supply, a controller, and peripheral circuits (not illustrated). The power supply, the controller, and the peripheral circuits are integrated on a circuit board, and the circuit board is received in the recess 122. It can be understood that, the touch interaction device 13 may further include a power switch and a mode switch (not illustrated). The power switch is configured to turn on or turn off power supply of the touch interaction device 13, and the mode switch is configured to switch the working modes (such as the game mode or the cool mode) of the touch interactive device 13. The power switch and the mode switch may be arranged on the circuit board or on the support body 131. It can be understood that, the power switch and the mode switch may also be replaced by a single switch button that can perform corresponding switch functions by distinguishing different pressing duration. For example, a long-press corresponds to turning on or turning off the power, a short-press is configured to switch between different working modes.

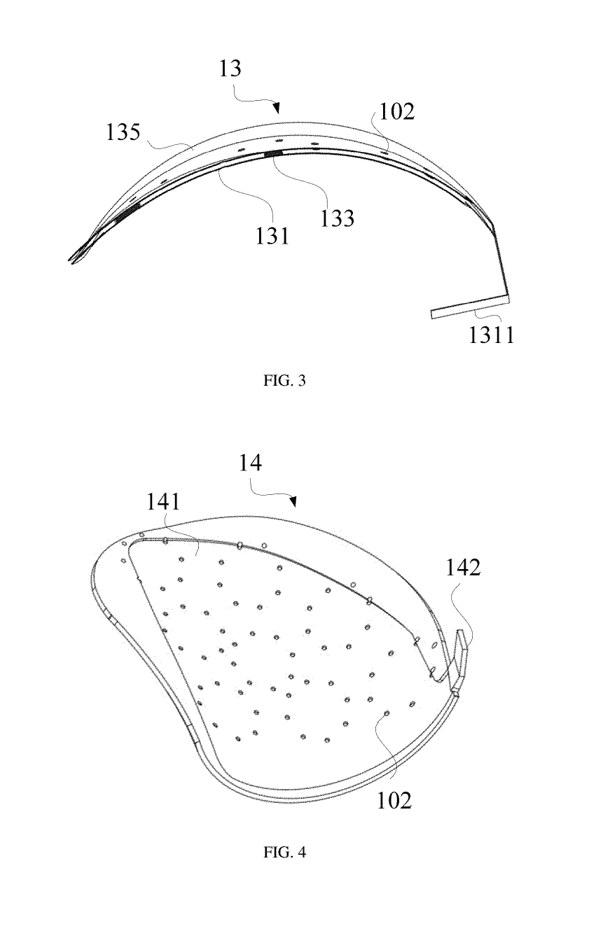

Referring to FIGS. 1 and 3, the support body 131 is attached to an upper surface of the vamp 11. The touch interaction device 13 further includes a flexible circuit board 1311 arranged at a position of the support body 131 corresponding to the groove 121. One end of the circuit board 1311 is electrically coupled to the plurality of light-emitting units 133 and the flexible touch sensor 135, and an other end passes the groove 121 and extends to the recess 122, and is electrically coupled to the control module 137. It can be understood that, the support body 131 may be a hollow double-layer structure or a non-hollow structure formed in one body. The light-emitting units 133 are embedded in the support body 131 and exposed from an upper surface of the support body 131. The support body 131 defines air holes 102 therein. The light-emitting units 133 are close to the air holes 102 and spaced apart from the air holes 102.

Referring to FIGS. 1 and 4, the shoe 10 further includes a cover 14. The cover 14 defines, on its lower surface, a limit recess 141 for receiving the support body 131. The cover 14 includes a baffle plate 142 arranged at a position corresponding to the groove 121. The baffle plate 142 is inserted into the groove 121 to cover the flexible circuit board 1311 and seals the groove 121. In the embodiment, the support body 131 and the cover 14 may be arranged on the vamp 11 in turn by glue bonding, and the cover 14 is made of a thin transparent material, so that the light emitted by the light-emitting units 133 can pass through the cover 14, and the flexible touch sensor 135 can receive the touch operations through the cover 14. Optionally, the cover 14 may also define a plurality of through-holes in positions each corresponding to one of the light-emitting units 133, the through-hole is slightly larger than the light-emitting unit 133, thereby exposing the light-emitting units 133 and the flexible touch sensor 135 covering the light-emitting units 133. It can be understood that, the vamp 11, the support body 131 and the cover 14 are all provided with air holes 102 that are correspondingly aligned and penetrated to each other, to achieve ventilation while wearing.

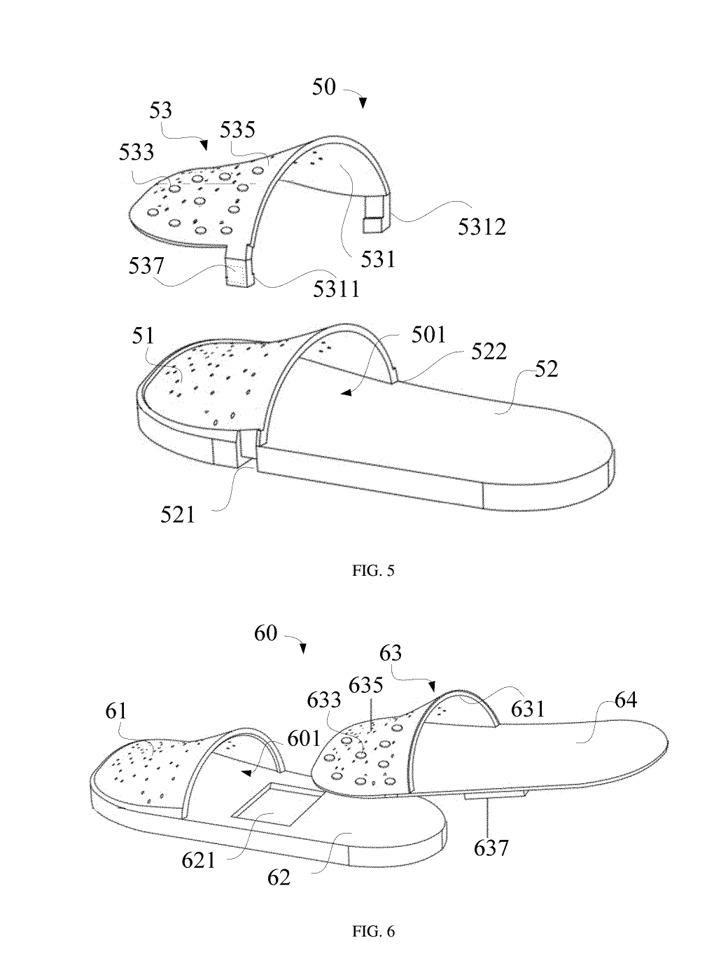

Referring to FIG. 5, in one embodiment of the present disclosure, a shoe 50 is provided, which includes a vamp 51 and a sole 52. The vamp 51 is coupled to the sole 52, and an opening 501 is formed between the vamp 51 and the sole 52 for wearing the shoe 50 for wearing the shoe 50 to a foot of a wearer. The shoe 50 further includes a touch interaction device 53. The touch interaction device 53 includes a support body 531, a light-emitting unit 533, a flexible touch sensor 535, and a control module 537. The support body 531 is attached to the vamp 51. In one embodiment, the amount of the light emitting units 533 is plural. A plurality of the light-emitting units 533 are arranged on the support body 531. The flexible touch sensor 535 is attached to the support body 531 and covers the light-emitting units 533. The control module 537 is electrically coupled to the light-emitting units 533 and the flexible touch sensor 535.

In one embodiment, the control module 537 controls the plurality of light-emitting units 533 to emit light according to a preset manner. The flexible touch sensor 535 detects a touch operation to the light-emitting units 533 during a preset time period in which at least one of the light-emitting units 533 is emitting light, and the control module 537 counts up when the touch operation to the light-emitting units 533 is detected. In an embodiment of the disclosure, the light-emitting units 533 are LEDs, and the flexible touch sensor 535 is a transparent flexible touch device.

In the present embodiment, the sole 52 defines a first groove 521 and a second groove 522 respectively on its two opposite sides close to the opening 501. The support body 531 includes a first holding portion 5311 and a second holding portion 5312 respectively extending from two sides of the support body 531 and corresponding to the first groove 521 and the second groove 522. The control module 537 is arranged in the first holding portion 5311, and is received in the first groove 521 through the first holding portion 5311. Alternatively, the control module 537 is arranged in the second holding portion 5312, and is received in the second groove 522 through the second holding portion 5312. The touch interaction device 53 is detachably coupled to the sole 52 through an engagement of the first holding portion 5311 and the first groove 521, and an engagement of the second holding portion 5312 and the second groove 522, respectively. It can be understood that, by detachably setting the touch interaction device 53 to a main body (i.e., the vamp 51 and the sole 52) of the shoe 50, it is convenient for the wearer to replace the main body or the touch interaction device 53 of the shoe 50 as needed.

It can be understood that, the touch interaction device 53 described in this embodiment differs from the touch interaction device 13 of the embodiment illustrated in FIG. 1 to FIG. 4 only in the structure and the combination with the vamp 51 and the sole 52. The function of the touch interaction device 53 may be the same as that of the touch interaction device 13, for example, the touch interaction device 53 may be operated in the game mode and the cool mode. Details may be referred to the related description in the embodiment illustrated in FIG. 1 to FIG. 4, which will not be described herein again.

Referring to FIG. 6, in one embodiment of the present disclosure, a shoe 60 is provided, which includes a vamp 61 and a sole 62. The vamp 61 is coupled to the sole 62, and an opening 601 is formed between the vamp 61 and the sole 62 for wearing the shoe 60 for wearing the shoe 60 to a foot of a wearer. The shoe 60 further includes a touch interaction device 63 and an inner pad 64. The touch interaction device 63 includes a support body 631, a light-emitting units 633, a flexible touch sensor 635, and a control module 637. The support body 631 is coupled to the inner pad 64, and is attached to a lower surface of the vamp 61. The light-emitting unit 633 is embedded in the support body 631. The flexible touch sensor 635 is attached to an upper surface of the support body 631 and covers the light-emitting unit 633. The inner pad 64 is attached to an upper surface of the sole 62. The control module 637 is arranged at a bottom of the inner pad 64, and electrically coupled to the light-emitting unit 633 and the flexible touch sensor 635 through a flexible circuit board (not illustrated). The sole 62 defines a receiving recess 621 at a position corresponding to the control module 637 for receiving the control module 637.

In one embodiment, the amount of the light emitting units 533 is plural. The control module 637 controls a plurality of the light-emitting units 633 to emit light according to a preset manner. The flexible touch sensor 635 detects a touch operation to the light-emitting units 633 during a preset time period in which at least one of the light-emitting units 633 is emitting light, and the control module 637 counts up when the touch operation to the light-emitting units 633 is detected. In an embodiment of the disclosure, the light-emitting units 633 are LEDs, and the flexible touch sensor 635 is a transparent flexible touch device. By connecting the support body 631 of the touch interaction device 63 with the inner pad 64, the touch interaction device 63 and the inner pad 64 together form a detachable structure, thereby facilitating the wearer to replace a main body (i.e., the vamp 61 and the sole 62) or the touch interaction device 63 and the inner pad 64 of the shoe 60 as needed.

It can be understood that, the function of the touch interaction device 63 described in this embodiment may be the same as that of the touch interaction device 13 of the embodiment illustrated in FIG. 1 to FIG. 4, for example, the touch interaction device 63 may be operated in the game mode and the cool mode. Details may be referred to the related description in the embodiment illustrated in FIG. 1 to FIG. 4, which will not be described herein again.

Referring to FIG. 7, in a first embodiment of the present disclosure, a control method of the shoe described in any one of the embodiments of FIG. 1 to FIG. 6 is provided, which includes at least the following operations.

At block 701, the flexible touch sensor detects a touch operation to the light-emitting units.

At block 702, the control module controls the light-emitting units to change their working states, according to the touch operation detected by the flexible touch sensor and a current working mode of the touch interaction device.

In the embodiment, the touch interaction device 13 is able to work in different working modes, such as a game mode, a cool mode, and so on.

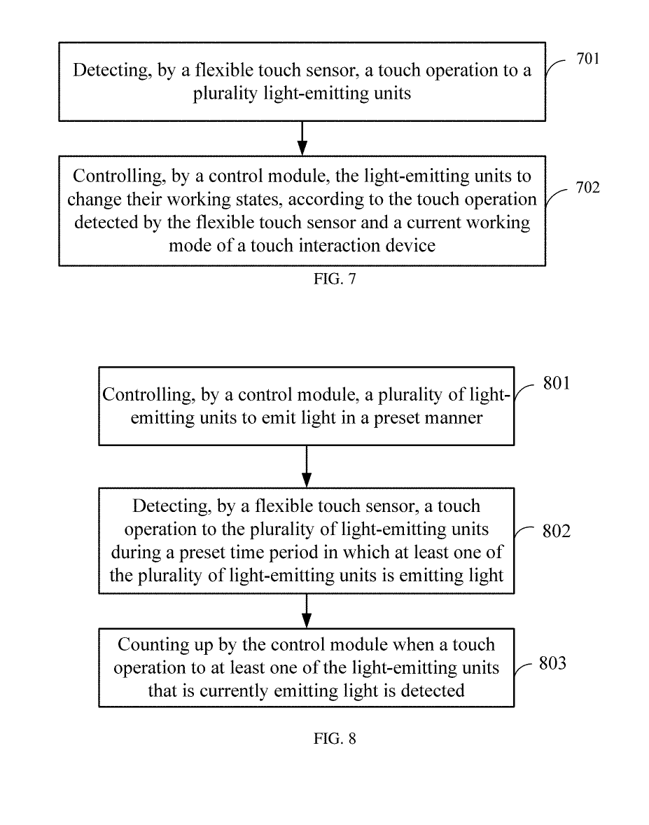

Referring to FIG. 8, in a second embodiment of the present disclosure, a control method of the shoe described in any one of the embodiments of FIG. 1 to FIG. 6 is provided, which includes at least the following operations. In the second embodiment, the touch interaction device works in a game mode.

At block 801, the control module controls the plurality of light-emitting units to emit light in a preset manner.

At block 802, the flexible touch sensor detects a touch operation to the plurality of light-emitting units during a preset time period in which at least one of the plurality of light-emitting units is emitting light.

At block 803, the control module counts up when a touch operation to at least one of the light-emitting units that is currently emitting light is detected.

In one embodiment, the control method further includes the follows after the touch operation to the at least one of the light-emitting units is detected. The at least one of the light-emitting units are triggered to change illuminating colors, and the audio module is triggered to play a first prompt tone.

In one embodiment, the control method further includes the follows. The flexible touch sensor detects a touch operation to the light-emitting units that aren't emitting light, during a preset time period in which at least one of the light-emitting units is emitting light. The audio module is triggered to play a second prompt tone, when the touch operation to at least one of light-emitting unit that isn't currently emitting light is detected.

It can be understood that, the operations and the specific implementation of the method in this embodiment may also be referred to the related description in the embodiment illustrated in FIG. 1 to FIG. 6, which will not be described herein again.

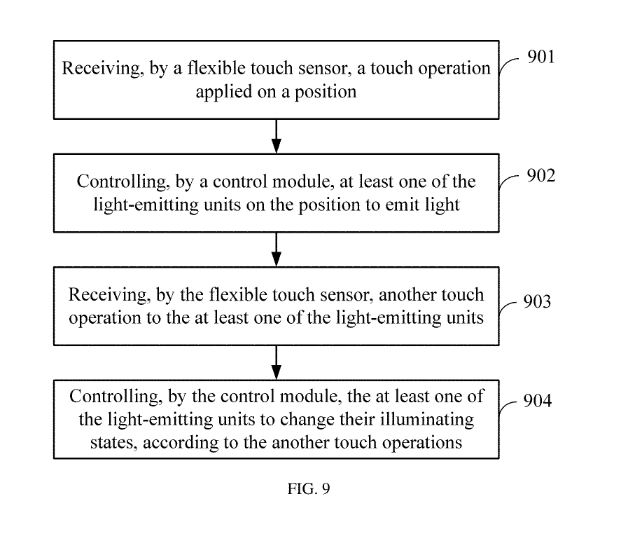

Referring to FIG. 9, in a third embodiment of the present disclosure, a control method of the shoe described in any one of the embodiments of FIG. 1 to FIG. 6 is provided, which includes at least the following operations. In the third embodiment, the touch interaction device works in a cool mode.

At block 901, the flexible touch sensor detects a touch operation to the light-emitting units.

At block 902, the control module controls the light-emitting units to change their working states, according to the touch operation detected by the flexible touch sensor and a current working mode of the touch interaction device.

At block 903, the flexible touch sensor receives another touch operation to the at least one of the light-emitting units.

At block 904, the control module controls the at least one of the light-emitting units to change their illuminating states, according to the another touch operations.

In one embodiment, the operation at block 904 may include the follows.

The flexible touch sensor receives a first touch operation to at least one light-emitting units, and the control module controls the at least one light-emitting units to change illuminating colors.

In one embodiment, the first touch operation is a long-press.

In one embodiment, the operation at block 904 may include the follows.

The flexible touch sensor receives a second touch operation to the at least one light-emitting units, and the control module controls the at least one light-emitting units to blink.

In one embodiment, the second touch operation is a double-click.

It can be understood that, the operations and the specific implementation of the method in this embodiment may also be referred to the related description in the embodiment illustrated in FIG. 1 to FIG. 6, which will not be described herein again.

According to the embodiments of the present disclosure, the shoe is provided with the support body on the vamp, and the plurality of light-emitting units and the flexible touch sensor covering at least the plurality of light-emitting units on the support body, so that the flexible touch sensor can detect the touch operations to the light-emitting units during the preset time period in which at least one of the light-emitting units is emitting light, and then the control module counts up when the touch operation to at least one of the light-emitting units which is currently emitting light is detected. Therefore, when the plurality of light-emitting units are controlled to emit light according to the preset manner, continuous game interaction can be achieved, thereby enhancing interaction with the wearer and increasing the fun of wearing.

The above is only the preferred embodiment of the present disclosure, and the scope of the present disclosure is not limited thereto. Those skilled in the art can understand all or part of the process of implementing the above embodiments, and equivalent changes made according to the claims of the present disclosure are still within the scope of the disclosure.

What is claimed is:

1. A shoe, comprising:
a sole and a vamp coupled to the sole, the sole and the vamp cooperating to define an opening between the vamp and the sole;
a touch interaction device, comprising:
a support body attached to the vamp;
a light-emitting unit arranged on the support body;
a flexible touch sensor attached to the support body and covering the light-emitting unit, the flexible touch sensor configured to detect a touch operation to the light-emitting unit; and
a control module electrically coupled to the light-emitting unit and the flexible touch sensor, the control module configured to control, according to the touch operation detected by the flexible touch sensor and a current working mode of the touch interaction device, the light-emitting unit to change its working states.

2. The shoe of claim 1, wherein the touch interaction device comprises a plurality of the light-emitting units;
the control module controls the plurality of light-emitting units to emit light according to a preset manner;
the flexible touch sensor detects a touch operation to the light-emitting units during a preset time period in which at least one of the light-emitting units is emitting light; and
the control module counts up when the touch operation to the light-emitting units is detected.

3. The shoe of claim 2, wherein the preset manner is controlling the plurality of light-emitting units to randomly emit light.

4. The shoe of claim 1, wherein the support body is attached to an upper surface of the vamp.

5. The shoe of claim 4, wherein the sole defines a recess on its bottom surface, and comprises a cover plate for sealing the recess, wherein the control module is received in the recess.

6. The shoe of claim 5, wherein the sole further defines, on its one side close to the opening, a groove communicating with the recess;
the touch interaction device further comprises a flexible circuit board arranged at a position of the support body corresponding to the groove, wherein the circuit board is electrically coupled to the plurality of light-emitting units and the flexible touch sensor through its one end, and an other end passes the groove and extends to the recess, and is electrically coupled to the control module.

7. The shoe of claim 6, wherein the shoe further comprises a cover arranged above the support body, wherein the cover defines, on its lower surface, a limit recess for receiving the support body;
the cover further comprises a baffle plate arranged at a position corresponding to the groove, wherein the baffle plate is inserted into the groove to cover the flexible circuit board and seals the groove.

8. The shoe of claim 7, wherein the cover is made of a transparent material, to cause the light emitted by the light-emitting units to be able to pass through the cover, and the flexible touch sensor be able to receive the touch operation through the cover; or
the cover further defines a plurality of through-holes in positions each corresponding to one of the light-emitting units, to expose the light-emitting units and the flexible touch sensor covering the light-emitting units.

9. The shoe of claim 4, wherein the sole defines a groove on its one side close to the opening, the control module is received in the groove.

10. The shoe of claim 9, wherein the support body comprises a holding portion arranged on a position corresponding to the groove, wherein the control module is arranged in the holding portion, and the touch interaction device is detachably coupled to the sole through an engagement of the holding portion and the groove.

11. The shoe of claim 1, wherein the shoe further comprises an inner pad attached to an upper surface of the sole, wherein the support body is coupled to the inner pad, and is attached to a lower surface of the vamp.

12. The shoe of claim 11, wherein the control module is arranged at a bottom of the inner pad;
the sole defines a receiving recess at a position corresponding to the control module for receiving the control module.

13. The shoe of claim 1, wherein the touch interaction device comprises a plurality of the light-emitting units;
the flexible touch sensor is further configured to receive touch operations to different light-emitting units;
the control module is configured to control, according to different positions at which the touch operations are received, at least one of the light-emitting units at the corresponding position to emit light; and control, according to different touch operations, the at least one of the light-emitting units at the corresponding position to change their illuminating states.

14. A control method of a shoe, the shoe comprising a touch interaction device which comprises a plurality of light-emitting units, a flexible touch sensor covering the light-emitting units, and a control module electrically coupled to the light-emitting units and the flexible touch sensor, the control method comprising:
detecting, by the flexible touch sensor, a touch operation to the light-emitting units; and
controlling, by the control module, the light-emitting units to change their working states, according to the touch operation detected by the flexible touch sensor and a current working mode of the touch interaction device.

15. The control method of claim 14, the control method further comprising:
controlling, by the control module, the plurality of light-emitting units to emit light in a preset manner, when the touch interaction device works in a game mode;
detecting, by the flexible touch sensor, a touch operation to the plurality of light-emitting units during a preset time period in which at least one of the plurality of light-emitting units is emitting light; and
counting up by the control module when a touch operation to at least one of the light-emitting units that is currently emitting light is detected.

16. The control method of claim 15, the control method further comprising the following after the touch operation to the at least one of the light-emitting units that is currently emitting light is detected:
controlling the at least one of the light-emitting units to change illuminating colors; and
controlling an audio module to play a first prompt tone.

17. The control method of claim 15, the control method further comprising:
controlling an audio module to play a second prompt tone when a touch operation to at least one of the light-emitting units that isn't currently emitting light is detected.

18. The control method of claim 14, the control method further comprising:
receiving, by the flexible touch sensor, a touch operation applied on a position, when the touch interaction device works in a cool mode; and
controlling, by the control module, at least one of the light-emitting units on the position to emit light.

19. The control method of claim 18, the control method further comprising at least one of the following:
receiving, by the flexible touch sensor, a first touch operation to at least one of the light-emitting units, and controlling, by the control module, the at least one of the light-emitting units to changes illuminating colors; and
receiving, by the flexible touch sensor, a second touch operation to at least one of the light-emitting units, and controlling, by the control module, the at least one of the light-emitting units to blink.

20. The control method of claim 18, the control method further comprising:
receiving, by the flexible touch sensor, another touch operation to the at least one of the light-emitting units;
controlling, by the control module, the at least one of the light-emitting units to change their illuminating states, according to the another touch operations.
